(19) United States
(12) Patent Application Publication
(10) Pub. No.: US 2026/0125950 A1
(43) Pub. Date: May 7, 2026

(54) COMPACT TYPE DUAL-MOTOR DRIVING AND FORCE BALANCE CONTROL DEVICE FOR ROLLER BLINDS

(71) Applicant: Fuyao University of Science and Technology, Fuzhou City (CN)

(72) Inventors: Hongxing WU, Fuzhou City (CN); Weiming SHEN, Fuzhou City (CN); Hui YOU, Fuzhou City (CN); Peng GAO, Fuzhou City (CN); Yijie KE, Fuzhou City (CN); Xianping LIU, Fuzhou City (CN); Yue WU, Fuzhou City (CN); Wei SHEN, Fuzhou City (CN)

(73) Assignee: Fuyao University of Science and Technology, Fuzhou City (CN)

(21) Appl. No.: 19/351,976

(22) Filed: Oct. 7, 2025

(30) Foreign Application Priority Data
Nov. 6, 2024 (CN) 202411573103.7

(51) Int. Cl. E06B 9/72; E06B 9/44

(52) U.S. Cl. CPC E06B 9/72; E06B 9/44; E06B 2009/725

(57) ABSTRACT

A compact type dual-motor driving and force balance control device for roller blinds is provided. A left aluminum alloy support is fixedly disposed at one end of the roller blind spool, a left driving motor is fixedly disposed on one side of the left aluminum alloy support, a left driving output planetary reducer is fittingly disposed at an output end of the left driving motor, a left planetary reducer torque output shaft is fixedly disposed at one end of the left driving output planetary reducer, and a left connecting plate is fixedly disposed at one end of the left planetary reducer torque output shaft.

### CROSS-REFERENCE TO RELATED APPLICATION

This patent application claims the benefit and priority of Chinese Patent Application No. 202411573103.7 filed with the China National Intellectual Property Administration on Nov. 6, 2024, the disclosure of which is incorporated by reference herein in its entirety as part of the present application.

### TECHNICAL FIELD

The present disclosure relates to the field of mechanical engineering automation technology, and in particular to, a compact type dual-motor driving and force balance control device for roller blinds.

### BACKGROUND

The existing electric actuator and reducer for window roller blinds are disposed externally, and generally employ a gear-screw speed-reduction mode. However, the conventional device not only has low speed-reduction efficiency, but also makes electric curtains unappealing due to its externally disposed motor and reduction gear. Moreover, the conventional device generally uses a single-motor and single-reducer driving mode, resulting in large size of the motor and reducer, which is not conducive to installation and maintenance. Thus, the conventional device is not conducive to meeting the requirements of making the electric roller blind system have simple and appealing appearance.

Therefore, based on the above conventional problems, a compact type dual-motor driving and force balance control device for roller blinds is proposed. Motors and reducers are installed inside a roller blind spool, so that the electric roller blinds and a power system are integrated to the utmost extent, achieving the best compact effect for the electric roller blinds and the power system, and making the appearance of the system simple and appealing.

### SUMMARY

The present disclosure is intended to provide a compact type dual-motor driving and force balance control device for roller blinds, for solving the problems as follows. The existing electric actuator and reducer for window roller blinds is disposed externally, and generally employs a gear-screw speed-reduction mode; however, the conventional device not only has low speed-reduction efficiency, but also makes electric curtains unappealing due to its externally disposed motor and reduction gear; moreover, the conventional device generally uses a single-motor and single-reducer driving mode, resulting in large size of the motor and reducer, which is not conducive to installation and maintenance; thus, the conventional device is not conducive to meeting the requirements of making the electric roller blind system have simple and appealing appearance.

To achieve the objective described above, the present disclosure provides the following technical solutions.

The technical solutions of the present disclosure are that a compact type dual-motor driving and force balance control device for roller blinds includes a roller blind spool; a left aluminum alloy support is fixedly disposed at one end of the roller blind spool, a left driving motor is fixedly disposed on one side of the left aluminum alloy support, a left driving output planetary reducer is fittingly disposed at an output end of the left driving motor, a left planetary reducer torque output shaft is fixedly disposed at one end of the left driving output planetary reducer, and a left connecting plate is fixedly disposed at one end of the left planetary reducer torque output shaft;
and a right aluminum alloy support is fixedly disposed at an other end of the roller blind spool, a right driving motor is fixedly disposed at one end of the right aluminum alloy support, a right driving output planetary reducer is fittingly disposed at an output end of the right driving motor, a right planetary reducer torque output shaft is fixedly disposed at one end of the right driving output planetary reducer, and a right connecting plate is fixedly disposed at one end of the right planetary reducer torque output shaft.

Further, the left driving motor and the right driving motor are electrically connected to a two-in-one integrated dual-motor controller.

Further, motor housing support bearings are fixedly disposed on peripheries of the left driving motor and the right driving motor, respectively.

Further, the left driving motor, the right driving motor, the left driving output planetary reducer and the right driving output planetary reducer are movably connected to an inner wall of the roller blind spool via the motor housing support bearings, and the left connecting plate and the right connecting plate are fixedly connected to the inner wall of the roller blind spool.

Further, two driving motors and two three-stage planetary reducers are used and are integrated into the roller blind spool, achieving a highly integrated and compact type electric roller blind system.

Further, the two driving motors are controlled by means of the two-in-one integrated controller, which achieves synchronous operation of dual motors.

Further, respective rotor positions of the dual motors are collected, the amount of deformation of the roller blind spool is determined based on a difference of the rotor positions, and the torque balance of the roller blind spool under the driving of the dual motors is calculated.

Further, the balance of force at both ends of the spool is calculated based on the motor rotor position difference, and a motor speed outer-loop control, inner-loop current real-time tracking, and torque dynamic distribution adjustment technology is proposed to achieve the torque balance and stable and reliable operation of the dual motors on the roller blind spool.

The technical solutions have the following beneficial effects.

A power source of the compact type dual-motor driving and force balance control device for roller blinds is provided with the left driving motor and the right driving motor of the same model, and output shafts of the left driving motor and the right driving motor are connected to the left driving output planetary reducer and the right driving output planetary reducer of the same model and the same reduction ratio, respectively; the left driving output planetary reducer and the right driving output planetary reducer both use three-stage planetary reduction, the output shafts of the left driving motor and the right driving motor are connected to first-stage sun gears in the left driving output planetary reducer and the right driving output planetary reducer via D-shaped shaft holes, respectively; output torques of the left driving motor and the right driving motor amplify a driving torque via the left driving output planetary reducer and the right driving output planetary reducer, and the left connecting plate and the right connecting plate of the output shafts of the left driving output planetary reducer and the right driving output planetary reducer are directly connected to an internal baffle plate of the roller blind spool respectively, thereby transmitting the torque to the roller blind spool and enabling the unfolding and folding actions of the roller blinds by the roller blind spool.

The left driving motor and the right driving motor of the compact type dual-motor driving and force balance control device for roller blinds are symmetrically mounted. In this way, when operating, the motors have opposite motor rotor rotating directions and opposite torque outputs. Since the left driving motor, the right driving motor, the left driving output planetary reducer, and the right driving output planetary reducer are movably mounted inside the roller blind spool via the motor housing support bearings, the electric roller blinds and the power system are integrated to the utmost extent, achieving the best compact effect of the electric roller blinds and the power system and making the appearance of the system simple and appealing.

Output ends of the left driving motor and the right driving motor of the compact type dual-motor driving and force balance control device for roller blinds are fixed by the left aluminum alloy support and the right aluminum alloy support respectively, and accordingly the way of using the aluminum alloy supports to connect the motors allows the motors to make full contact with the aluminum alloy supports, achieving excellent heat dissipation.

The compact type dual-motor driving and force balance control device for roller blinds is driven by the left driving motor and the right driving motor of the same models. Motor drivers use a two-in-one integrated dual-motor controller having two independent driving channels and driving modules. The two-in-one integrated dual-motor controller adopts one microcontroller unit (MCU) to uniformly control motor driving systems to output pulse width modulation (PWM) current to control the motor. The design of the controller of this structure may achieve synchronized control of two motors. By using the independent driving channels, the controller can independently control and adjust the independent winding current of the respective motors.

The compact dual-motor driving and force balance control device for roller blinds uses two motors to drive the roller blind spool simultaneously. Since the consistency and synchronization of the output torques of the two motors are involved, a speed outer-loop control, inner-loop real-time current tracking, and dynamic torque distribution adjustment technology is adopted to achieve the torque balance and stable and reliable operation of the two motors in the roller blind spool. Motor rotor position sensors are integrated inside the two motors, which can detect the motor rotor positions accurately. Due to the flexibility of the roller blind spool, when different rotational torques are applied to two ends of the roller blind spool, the roller blind spool deforms to a certain extent, and the amount of deformation of the roller blind spool and the output difference of the two motors have a functional relationship. Therefore, by detecting the rotor position values of the two motors and calculating the amount of deformation of the roller blind spool, a force balance difference value of the roller blind spool can be calculated, and accordingly, a real-time torque difference of the motors can be calculated by an algorithm of the MCU based on this difference.

A speed outer-loop control, inner-loop current real-time tracking, and torque dynamic distribution adjustment technology module is used to receive an action rotating speed command for the external roller blinds, and the MCU collects the speed of a driving motor A and the speed of a driving motor B, where the driving motor A is the left driving motor and the driving motor B is the right driving motor, which achieve closed-loop control on the speed of the roller blind spool. A roller blind spool rotating speed closed-loop module employs a PI control algorithm to output a desired current given value of the system. This current given value serves as an input value for a current dynamic adjustment algorithm module. By combining the motor's electromagnetic parameters with the real-time torque difference calculated by the MCU, the current dynamic adjustment algorithm module outputs the driving torque required by the entire roller blind system. Through a torque distribution adjustment algorithm module, the torques of the driving motor A and the driving motor B are distributed in real time. Then, based on a PWM signal from a PWM generator, A and B power driving channels are driven, enabling independent and real-time control of the winding current of the driving motor A and the winding current of the driving motor B until the spool force balance difference that is calculated from the motor rotor position signal is zero, thereby achieving the torque balance between the two driving motors in the roll blind spool.

### BRIEF DESCRIPTION OF THE DRAWINGS

FIG. 1 is a schematic structural diagram of a compact type dual-motor driving and force balance control device for roller blinds according to the present disclosure; and

FIG. 2 is a block diagram of a dual-motor output torque balancing algorithm used in a compact type dual-motor driving and force balance control device for roller blinds according to the present disclosure.

List of corresponding reference signs in the figures: 1 left aluminum alloy support; 2 left driving motor; 3 left driving output planetary reducer; 4 left planetary reducer torque output shaft; 5 left connecting plate; 6 roller blind spool; 7 right connecting plate; 8 right planetary reducer torque output shaft; 9 right driving output planetary reducer; 10 driving motor; 11 motor housing support bearing; 12 right aluminum alloy support; 13 two-in-one integrated dual-motor controller.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the embodiments of the present disclosure, all other embodiments that can be obtained by those of ordinary skill in the art without creative efforts shall fall within the scope of protection of the present disclosure.

### Embodiment 1

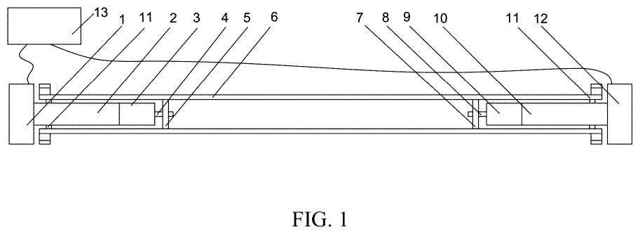

Referring to FIG. 1, the present disclosure provides a technical solution: a compact type dual-motor driving and force balance control device for roller blinds includes a roller blind spool 6; a left aluminum alloy support 1 is fixedly mounted at one end of the roller blind spool 6, a left driving motor 2 is fixedly mounted on one side of the left aluminum alloy support 1, a left driving output planetary reducer 3 is fittingly mounted at an output end of the left driving motor 2, a left planetary reducer torque output shaft 4 is fixedly mounted at one end of the left driving output planetary reducer 3, and a left connecting plate 5 is fixedly mounted at one end of the left planetary reducer torque output shaft 4; a right aluminum alloy support 12 is fixedly mounted at the other end of the roller blind spool 6, a right driving motor 10 is fixedly mounted at one end of the right aluminum alloy support 12, a right driving output planetary reducer 9 is fittingly mounted at an output end of the right driving motor 10, a right planetary reducer torque output shaft 8 is fixedly mounted at one end of the right driving output planetary reducer 9, and a right connecting plate 7 is fixedly mounted at one end of the right planetary reducer torque output shaft 8; the left driving motor 2 and the right driving motor 10 are electrically connected to a two-in-one integrated dual-motor controller 13; motor housing support bearings 11 are fixedly mounted on peripheries of the left driving motor 2 and the right driving motor 10, respectively; and the left driving motor 2, the right driving motor 10, the left driving output planetary reducer 3 and the right driving output planetary reducer 9 are movably connected to an inner wall of the roller blind spool 6 via the motor housing support bearings 11, and the left connecting plate 5 and the right connecting plate 7 are fixedly connected to the inner wall of the roller blind spool 6.

A specific implementation process is as follows.

A power source of the compact type dual-motor driving and force balance control device for roller blinds is provided with the left driving motor 2 and the right driving motor 10 of the same model, and output shafts of the left driving motor 2 and the right driving motor 10 are connected to the left driving output planetary reducer 3 and the right driving output planetary reducer 9 of the same model and the same reduction ratio, respectively. The left driving output planetary reducer 3 and the right driving output planetary reducer 9 both use three-stage planetary reduction, the output shafts of the left driving motor 2 and the right driving motor 10 are connected to first-stage sun gears in the left driving output planetary reducer 3 and the right driving output planetary reducer 9 via D-shaped shaft holes, respectively. Output torques of the left driving motor 2 and the right driving motor 10 amplify a driving torque via the left driving output planetary reducer 3 and the right driving output planetary reducer 9, and the left connecting plate 5 and the right connecting plate 7 of the output shafts of the left driving output planetary reducer 3 and the right driving output planetary reducer 9 are directly connected to an internal baffle plate of the roller blind spool 6 respectively, thereby transmitting the torque to the roller blind spool 6 and enabling the unfolding and folding actions of the roller blinds by the roller blind spool 6.

The left driving motor 2 and the right driving motor 10 of the compact type dual-motor driving and force balance control device for roller blinds are symmetrically mounted. In this way, when operating, the motors have opposite motor rotor rotating directions and opposite torque outputs. Since the left driving motor 2, the right driving motor 10, the left driving output planetary reducer 3, and the right driving output planetary reducer 9 are movably mounted inside the roller blind spool 6 via the motor housing support bearings 11, the electric roller blinds and the power system are integrated to the utmost extent, achieving the best compact effect of the electric roller blinds and the power system and making the appearance of the system simple and appealing.

Output ends of the left driving motor 2 and the right driving motor 10 of the compact type dual-motor driving and force balance control device for roller blinds are fixed by means of the left aluminum alloy support 1 and the right aluminum alloy support 12 respectively, and accordingly the way of using the aluminum alloy supports to connect the motors allows the motors to make full contact with the aluminum alloy supports, achieving excellent heat dissipation.

The compact type dual-motor driving and force balance control device for roller blinds is driven by the left driving motor 2 and the right driving motor 10 of the same models. Motor drivers use a two-in-one integrated dual-motor controller 13 having two independent driving channels and driving modules. The two-in-one integrated dual-motor controller 13 adopts one MCU to uniformly control motor driving systems to output PWM current to control the motor. The design of the controller of this structure may achieve synchronized control of two motors. By using the independent driving channels, the controller can independently control and adjust the independent winding current of the respective motors.

### Embodiment 2

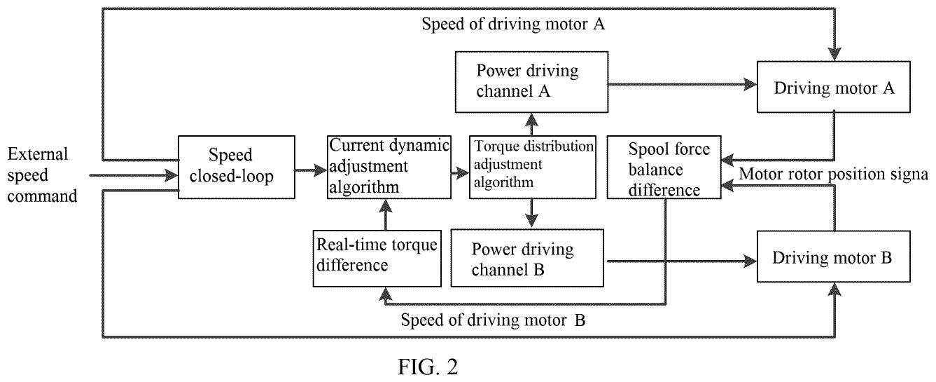

Referring to FIGS. 1 and 2, the present disclosure provides a technical solution as follow: a compact type dual-motor driving and force balance control device for roller blinds involves a dual-motor driving torque balancing function and a control algorithm; the algorithm function is composed of a roller blind speed closed-loop module, a current dynamic adjustment algorithm module, a torque distribution adjustment algorithm module, an A and B power driving channel PWM control module, a driving motor A, a driving motor B, a spool force balance difference and acquisition module, a real-time torque difference calculation algorithm module, as shown in FIG. 2.

Two motors are used for driving the roller blind spool simultaneously. Since the consistency and synchronization of the output torques of the two motors are involved, a speed outer-loop control, inner-loop real-time current tracking, and dynamic torque distribution adjustment technology is adopted to achieve the torque balance and stable and reliable operation of the two motors in the roller blind spool. Motor rotor position sensors are integrated inside the two motors, which can detect the motor rotor positions accurately. Due to the flexibility of the roller blind spool, when different rotational torques are applied to two ends of the roller blind spool, the roller blind spool deforms to a certain extent, and the amount of deformation of the roller blind spool and the output difference of the two motors have a functional relationship. Therefore, by detecting the rotor position values of the two motors and calculating the amount of deformation of the roller blind spool, a force balance difference value of the roller blind spool 6 can be calculated, and accordingly, a real-time torque difference of the motors can be calculated by an algorithm of the MCU based on this difference.

A speed outer-loop control, inner-loop current real-time tracking, and torque dynamic distribution adjustment technology module is used to receive an action rotating speed command for the external roller blinds, and the MCU collects the speed of a driving motor A and the speed of a driving motor B, where the driving motor A is the left driving motor 2 and the driving motor B is the right driving motor 10, which achieve closed-loop control on the speed of the roller blind spool. A roller blind spool rotating speed closed-loop module employs a PI control algorithm to output a desired current given value of the system. This current given value serves as an input value for a current dynamic adjustment algorithm module. By combining the motor's electromagnetic parameters with the real-time torque difference calculated by the MCU, the current dynamic adjustment algorithm module outputs the driving torque required by the entire roller blind system. Through a torque distribution adjustment algorithm module, the torques of the driving motor A and the driving motor B are distributed in real time. Then, based on a PWM signal from a PWM generator, A and B power driving channels are driven, enabling independent and real-time control of the winding current of the driving motor A and the winding current of the driving motor B until the spool force balance difference that is calculated from the motor rotor position signal is zero, thereby achieving the torque balance between the two driving motors in the roll blind spool 6.

The above are merely embodiments of the present disclosure, and general knowledge such as specific technical solutions or features known in the solutions is not described too much herein. It should be noted that several modifications and improvements can also be made by those skilled in the art without departing from the technical solutions of the present disclosure, and these should also be considered within the scope of protection of the present disclosure, none of which would affect the effectiveness of the implementation of the present disclosure or the practical applicability of the patent. The scope of protection claimed in the present disclosure shall be subject to the content of the claims, and the specific embodiments described in the specification may be used to explain the content of the claims.

What is claimed is:

1. A compact type dual-motor driving and force balance control device for roller blinds, comprising a roller blind spool (6), wherein a left aluminum alloy support (1) is fixedly disposed at one end of the roller blind spool (6), a left driving motor (2) is fixedly disposed on one side of the left aluminum alloy support (1), a left driving output planetary reducer (3) is fittingly disposed at an output end of the left driving motor (2), a left planetary reducer torque output shaft (4) is fixedly disposed at one end of the left driving output planetary reducer (3), and a left connecting plate (5) is fixedly disposed at one end of the left planetary reducer torque output shaft (4); and
a right aluminum alloy support (12) is fixedly disposed at an other end of the roller blind spool (6), a right driving motor (10) is fixedly disposed at one end of the right aluminum alloy support (12), a right driving output planetary reducer (9) is fittingly disposed at an output end of the right driving motor (10), a right planetary reducer torque output shaft (8) is fixedly disposed at one end of the right driving output planetary reducer (9), and a right connecting plate (7) is fixedly disposed at one end of the right planetary reducer torque output shaft (8).

2. The compact type dual-motor driving and force balance control device for roller blinds according to claim 1, wherein the left driving motor (2) and the right driving motor (10) are electrically connected to a two-in-one integrated dual-motor controller (13).

3. The compact type dual-motor driving and force balance control device for roller blinds according to claim 1, wherein motor housing support bearings (11) are fixedly disposed on peripheries of the left driving motor (2) and the right driving motor (10), respectively.

4. The compact type dual-motor driving and force balance control device for roller blinds according to claim 1, wherein the left driving motor (2), the right driving motor (10), the left driving output planetary reducer (3) and the right driving output planetary reducer (9) are movably connected to an inner wall of the roller blind spool (6) via the motor housing support bearings (11), and the left connecting plate (5) and the right connecting plate (7) are fixedly connected to the inner wall of the roller blind spool (6).
